(19) United States
(12) Patent Application Publication
(10) Pub. No.: US 2014/0320542 A1
(43) Pub. Date: Oct. 30, 2014

(54) DEVICE AND METHOD OF INFORMATION TRANSFER

(71) Applicant: SONY MOBILE COMMUNICATIONS, INC., Minato-ku (JP)

(72) Inventor: Tetsuya NARUSE, Kanagawa (JP)

(73) Assignee: SONY MOBILE COMMUNICATIONS, INC., Minato-ku (JP)

(21) Appl. No.: 13/872,522

(22) Filed: Apr. 29, 2013

(51) Int. Cl. G09G 5/10

(52) U.S. Cl. CPC G09G 5/10
USPC 345/690

(57) ABSTRACT

Discussed herein is a method to transfer information from an output side terminal of a first device to an input side terminal of a second device. Information is enclosed in a predetermined region on the display panel of the device and is transmitted by changing the brightness (luminance) or the RGB color of the image with respect to time. A sensor positioned within the predetermined region detects the modulated luminance value of the information and demodulates the detected luminance to acquire the information. After performing the demodulation process, the acquired information is displayed on a display panel.

### BACKGROUND

1. Field of the Disclosure

This disclosure relates to a method for transferring data between mobile terminals by modifying the brightness/RBG value of data displayed on a screen.

2. Description of the Related Art

Mobile devices, such as smart phones, tablets or the like are available for displaying data on a screen. The displayed data may comprise pictures, text, videos, or web pages.

The mobile devices may include a touch screen, which may be configured to accept a user's input in the form of a touch operation. The touch operation may correspond to the user contacting the surface of the touch screen with an instruction object, such as a finger or stylus. A commonly encountered scenario in the usage of such mobile devices is a data transfer operation, wherein information (data) displayed on a display panel of one mobile terminal device, referred to herein as a transmitting device, is transferred to another mobile terminal device referred to herein as a receiving device.

In traditional contact less transactions such as near field communications that are used to read two-dimensional bar codes, infrared rays communications or the like, a critical requirement while performing the data transfer operation is that of having an element of the transmitting device (which is configured to transmit information), align precisely with an element of the receiving device (which is configured to receive the transmitted information) so that the transfer operation can be performed successfully.

Further, the positions of the transmitting element and the receiving element are fixed and cannot be changed by a user. A slight deviation from the desired alignment results in an inaccurate transfer of data. Accordingly, there is a requirement to enable a successful data transfer mechanism, even though the transmitting/receiving elements are not exactly aligned with respect to one another.

### SUMMARY

Devices and methods for correctly and easily transferring data from a transmitting device to a receiving device are discussed herein.

According to one exemplary embodiment, the disclosure is directed to an information processing apparatus comprising: circuitry configured to modulate data to be communicated to another information processing apparatus; and control a display to modify at least one of a luminance value and a color value of information displayed at the display with respect to time based on the modulated data.

According to another exemplary embodiment, the disclosure is directed to an information processing method performed by an information processing apparatus, the method comprising: modulating data to be communicated to another information processing apparatus; and controlling a display to modify at least one of a luminance value and a color value of information displayed at the display with respect to time based on the modulated data.

According to another exemplary embodiment, the disclosure is directed to a non-transitory computer-readable medium including computer program instructions, which when executed by an information processing apparatus, cause the information processing apparatus to perform a process, the process comprising: modulating data to be communicated to another information processing apparatus; and controlling a display to modify at least one of a luminance value and a color value of information displayed at the display with respect to time based on the modulated data.

The foregoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 depicts a data transfer operation between a transmitting device and a receiving device;

FIGS. 2A and 2B depict a non-limiting example illustrating data transfer from a business card;

FIG. 3 illustrates schematically an exemplary mobile phone terminal device;

FIG. 4 illustrates a graph representing the demodulation performed by a mobile phone device;

FIG. 5 illustrates an exemplary flowchart depicting the steps taken by a transmitting and receiving device while performing a data transfer;

FIG. 6 illustrates a non-limiting example depicting a data transfer from a tablet to a smart phone;

FIG. 7 illustrates another non-limiting example depicting the data transfer process in a board game;

FIG. 8 illustrates a non-limiting example depicting the control of a motor vehicle accessory disposed on a display panel of the transmitting device;

FIG. 9 illustrates a structural configuration of components used to control the motor vehicle accessory of FIG. 8;

FIG. 10 illustrates another non-limiting example depicting the control of a motor vehicle accessory disposed on a display panel of the transmitting device;

FIG. 11 illustrates an exemplary flowchart depicting the steps taken by the transmitting device to control the motor vehicle accessory of FIG. 10;

FIG. 12 illustrates another example depicting the control of a motor vehicle accessory by a remote control transmitting device;

FIG. 13 illustrates an exemplary flowchart depicting the steps taken by the transmitting device and the motor vehicle accessory of FIG. 12;

FIG. 14 illustrates an exemplary flowchart depicting another method to control the motor vehicle accessory of FIG. 12.

### DETAILED DESCRIPTION

Referring now to the drawings, wherein like reference numerals designate identical or corresponding parts throughout the several views.

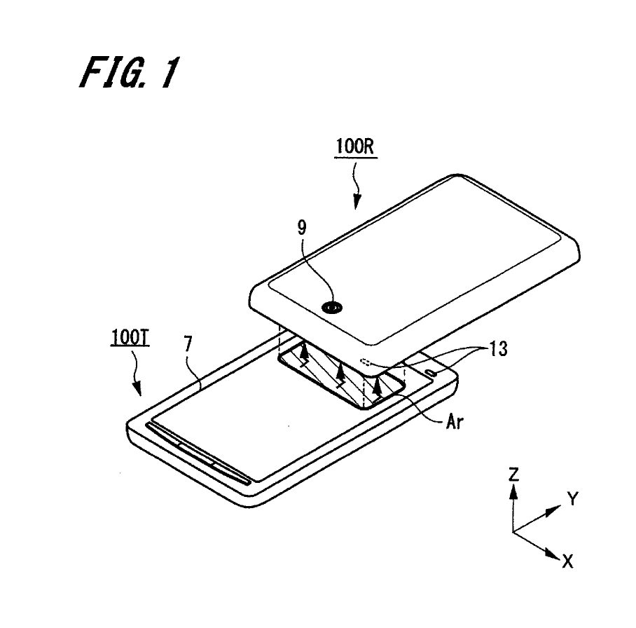

FIG. 1 depicts a non-limiting example illustrating a data transfer operation between a transmitting device and a receiving device. In FIG. 1, a mobile phone device 100T is a transmitting device (hereinafter referred to as a transmission side terminal), and a mobile phone device 100R is a receiving device (hereinafter referred to as a receiving side terminal). Note that the receiving device is positioned in a manner such that the display screen of 100R faces the display screen of the transmission terminal 100T.

The transmitting and receiving terminals are positioned in such a manner such that a photo sensor 13 of the receiving terminal is positioned in the vicinity of the display screen 7 of the transmitting terminal. The photo sensor can be an illumination intensity sensor that is configured to detect the illumination (luminance) of a region of information displayed on the screen or an RGB color sensor that is configured to detect the intensities of the primary colors of red, green and blue. The region from the display panel 7 which encloses the data to be transmitted to the receiving side terminal is depicted as Ar and can be set by the user with, the use of a touch operation. The transmission terminal 100T transmits the desired data by changing the luminance value of the image with respect to time. The receiving terminal 100R demodulates the illumination intensity detected by the photo sensor 13 and thereby acquires the data transmitted by the transmission device 100T.

Alternatively, the transmission terminal 100T can transmit the desired data by changing the RGB value of the image with respect to time. The receiving terminal demodulates the RGB value detected by the photo sensor to acquire the transmitted data. Further, note that the data transmission mechanism is not restricted to the above described methods. A combination of changing the luminance (brightness) and/or changing the intensities of the primary colors (RGB) can also be utilized to accomplish a successful data transfer.

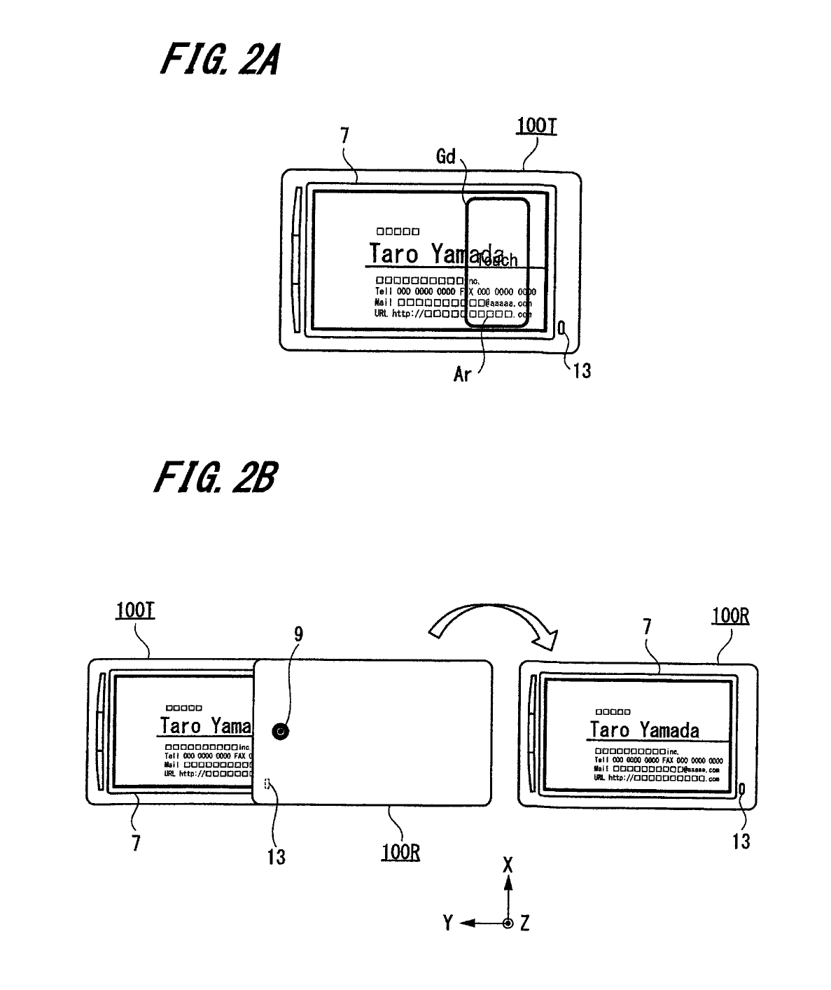

FIGS. 2A and 2B depict a non-limiting example illustrating a data transfer operation from a business card. FIG. 2A depicts the business card displayed on a display screen (also referred to herein as a display panel) of the transmitting terminal 100T. The area (Ar) set by the user is represented by a guide (Gd) denoted by a ‘touch’ area on the display panel of the transmitting device. To transfer the information within the guide, the receiving terminal 100R can be positioned in such a manner such that the photo sensor 13 of the receiving device is located within the guide Gd. The transmitting device modulates the luminance and/or RGB value of the data within the region Ar with respect to time and transmits the modulated data to the receiving device where upon it is detected by the photo sensor 13.

FIG. 2B depicts the data transfer operation of the business card wherein, the receiving device receives the entire contents of the business card from the transmitting device, by performing a sliding operation in a horizontal position (the Y axis direction) with respect to the display screen of the transmitting device 100T. Note that the entire business card can be selected by the user at the transmitting terminal and the receiving terminal 100R, acquires the business card information by demodulating the detected value of the photo sensor 13. The transmission of data from the transmitting device to the receiving device can be performed in a complete optical (wireless) manner. Alternatively, a hybrid approach that includes optical and RF communication can be used. In this method, the optical communication implements a handover of a connection ID that is required for pairing to the RF communication such as Bluetooth, Wi-Fi, etc.

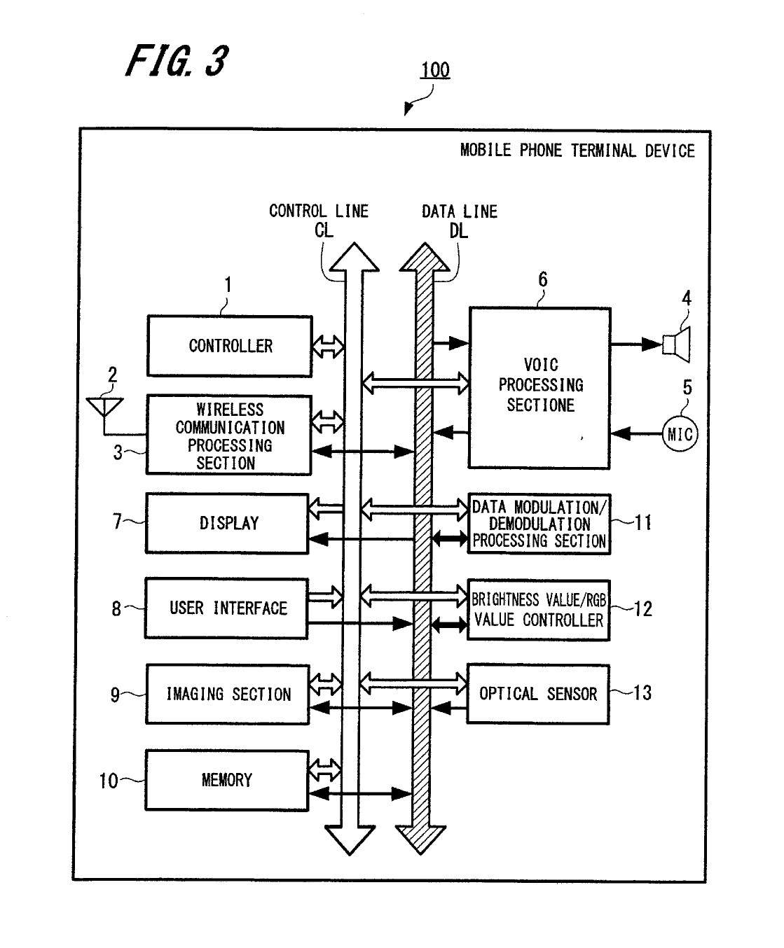

Furthermore, note that the position of the data transmission region Ar can be set to any arbitrary position by the user on the display panel of the transmitting device. FIG. 3 illustrates a schematic block diagram of an exemplary mobile phone terminal device 100. The structure of the mobile phone terminal device shown in FIG. 3, is common to both, the transmission terminal and the receiving terminal.

As shown in FIG. 3, the mobile phone terminal device 100 may include an antenna 2 and a wireless communication processing section 3. The wireless communication processing section 3 may communicate wirelessly via radio signals, or the like, with other mobile devices via, e.g., a base station. Further, a data signal, such as a voice transmission from another user, may be received by antenna 2 and sent to the wireless communication processing section 3 for further processing. In the case of an incoming voice transmission, the voice data signal may be sent from the wireless communication processing section 3 to a voice processing section 6. Incoming voice data received by the voice processing section 6 via the wireless communication processing section 3 may be output as sound via a speaker 4.

Conversely, an outgoing voice signal may be supplied by a user to the voice processing section 6 via a microphone 5. The voice signal received via microphone 5 and processed by the voice processing section 6 may be sent to wireless communication processing section 3 for transmission by the antenna 2.

An optical sensor unit 13 may be provided in the mobile phone terminal device 100, that is configured to detect changes in luminance and/or RBG value of a region of a display panel. As stated previously, the sensor 13 may be a illumination intensity sensor or an RBG color sensor. A brightness value controller 12 controls the luminance value and/or the RBG value of an image displayed in a transmission region Ar.

A data modulation/demodulation unit 11, can be configured to modulate the data stored in the memory or demodulate the detected data by the photo sensor. Note that while the modulation process is performed, data is modulated to a luminance value. Specifically, data to be transmitted is substituted by the amplitude of a luminance value. While performing the demodulation process, unit 11 demodulates the data by converting the digital value acquired by the photo sensor into data previously matched with the digital value. Further, the data modulation/demodulation process can also be based on changing the RGB value of the information to be transmitted. Accordingly, the receiver demodulates the RGB value to acquire the transmitted information.

The mobile phone terminal device 100 may include a display 7. The display 7 may be, e.g., a liquid crystal display (LCD) panel, an organic electroluminescent (OLED) display panel, a plasma display panel, or the like. The display 7 may display text, an image, a web page, a video, or the like. For example, when the mobile phone terminal device 100 connects with the Internet, the display 120 may display text and/or image data which is transmitted from a web server in Hyper Text Markup Language (HTML) format and displayed via a web browser. The display 7 may additionally display data stored in a memory 10.

A touch panel unit can be provided which detects a touch operation on the surface of the display 7. For example the touch panel can detect a touch operation performed by an instruction object, such as a finger or stylus. Touch operations may correspond to user inputs, such as a selection of an icon or a character string displayed on the display 7. Further, a user interface unit 8, is provided which can comprise a plurality of buttons that are configured to generate an operation signal based on the input by a user. An imaging unit 9 can comprise a charged coupled device (CCD), complementary metal oxide semiconductor (CMOS) sensor or the like and can be configured to capture an image to be transferred.

Data which is detected and processed by the optical sensor 13 can be transmitted to a controller 1. The controller 1 may include one or more processor units and can control each element of the mobile phone terminal device 100 based on data detected by the optical sensor, or by inputs received from imaging unit.

The controller 1 may execute instructions stored in the memory 10. To this end, the memory 10 may be a non-transitory computer readable medium having instructions stored therein for controlling the mobile phone terminal device 100. Further, the controller 1 may include one or more processors for executing the instructions stored on the memory 10. The memory 10 may additionally store information pertaining data modulation processing unit 11 of the mobile phone terminal device. Specifically, it may store the computational results of a modulation/demodulation process.

Note that the processing features of the controller 1 are not limited to using the above described information, and other methods of performing these features may be utilized.

The mobile phone terminal device 100 can include a control line CL and a data line DL as internal bus lines for communication. The control line CL can be used to transmit control data from the controller 110. The data line DL may be used for the transmission of voice data, display data, or the like, throughout the various elements of the mobile phone terminal device 100.

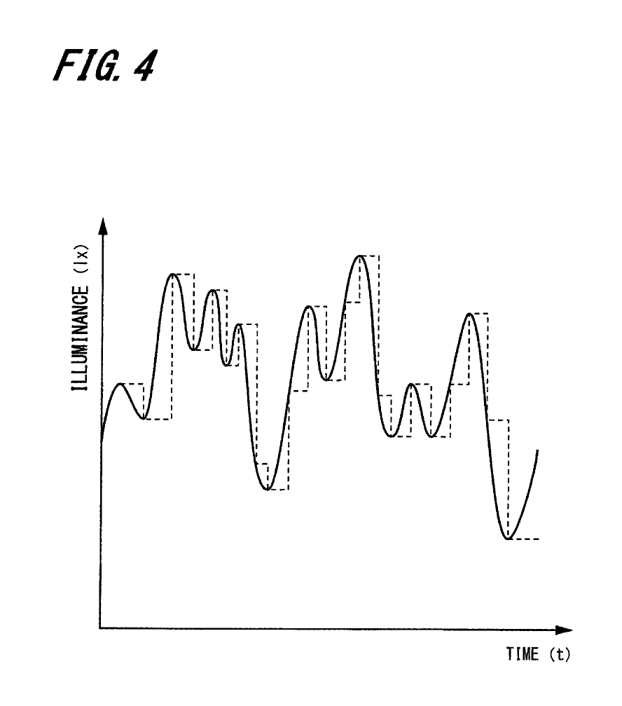

FIG. 4 illustrates a graph representing the demodulation process performed by the data modulation/demodulation processing unit (unit 11 in FIG. 3) of the mobile phone device. As shown in FIG. 4, the magnitude of illuminance (i.e., illumination intensity) which is detected by the photo sensor 13 is represented on the vertical axis and time (t) is represented on the horizontal axis.

The data processing unit 11, detects an analog signal by the photo sensor 13 and converts it into a digital format based on a predetermined sampling rate. For example, an analog value may be converted into a digital signal that is represented by 3 bits. In other words, each sample of the detected analog signal can be represented by 3 bits at each sampling instant. Thus, for a sampling frequency of 10 Hz, the transmission terminal 100T can achieve a transmission rate of 30 bits per second (3 bits per frame×10 frames per second).

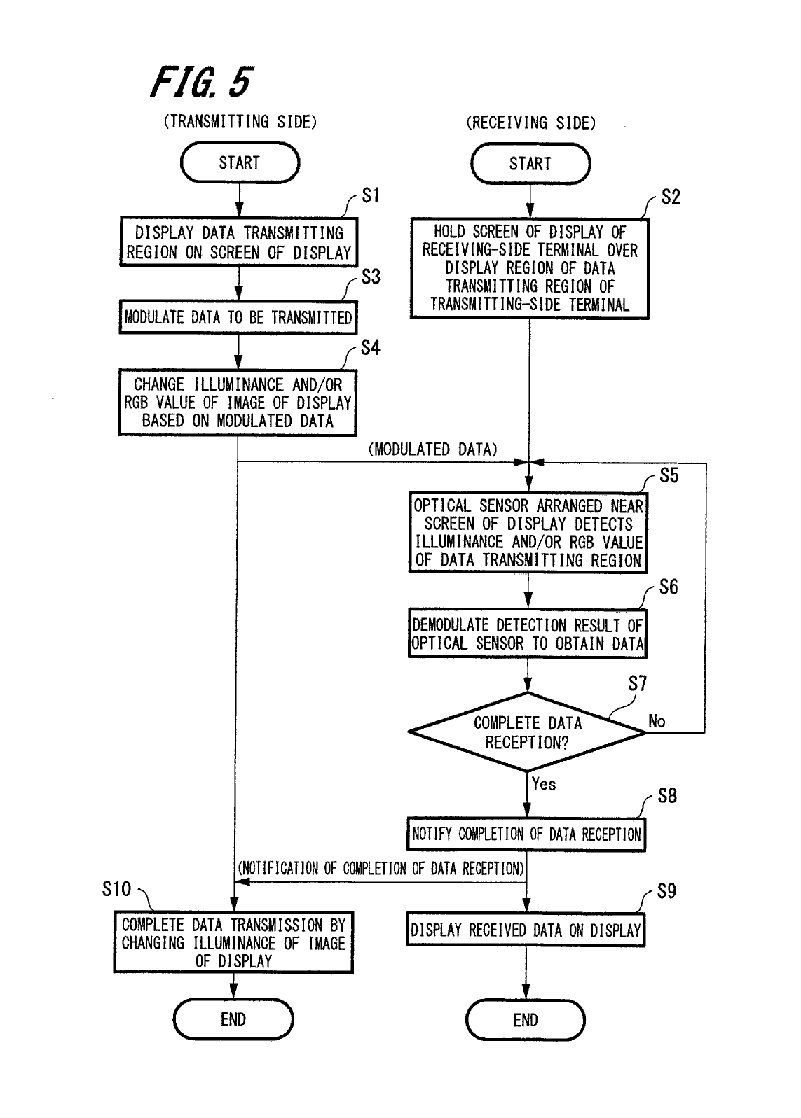

FIG. 5 illustrates an exemplary flowchart depicting the steps taken by the transmitting and receiving terminals while performing a data transfer. In step S1, the data transmission region Ar is displayed on the display panel 7 of the transmitting terminal 100T.

In step S2 the display panel of the receiving terminal 100R is positioned in a manner such that a photo sensor of the receiving terminal is within the data transmission region Ar of the transmission device 100T. In step S3, the data to be transmitted by the transmitting terminal 100T is modulated. In step S4 the transmission terminal 100T modifies the luminance value and/or the RGB value of the image which is displayed within the transmission region Ar.

In step S5 the receiving terminal 100R detects the illumination intensity and/or RGB value of the data (i.e., the modulated data of the data transmission region Ar) by the photo sensor 13. Note that the photo sensor 13 is placed in the vicinity of the display panel 7. In step S6, the receiving terminal 100R detects the data transmitted and demodulates the data (as described with reference to FIG. 4) to obtain the original data transmitted from the transmission device 100T. In step S7 a query is made to check if the data transfer process is completed. If the response to the query is affirmative the process proceeds to step S8 wherein a notification of data reception is sent by the receiving device 100R to the transmitting terminal 100T. Note, that the notification can be transmitted by using a near field communication technique using radio waves that require a simple set up and that operate at smaller distances or can alternatively be transmitted by using a Bluetooth technology or a microwave communication channel.

However if the data transfer is not completed the process moves to step S5 wherein the optical sensor continues to extract the images from the display area of the transmitting terminal. In step S9, the data received and processed at the receiving terminal 100R is displayed on its display panel. In step S10 the transmitting terminal 100T completes the data transmission and thereby changes the luminance of the image to its original intensity value

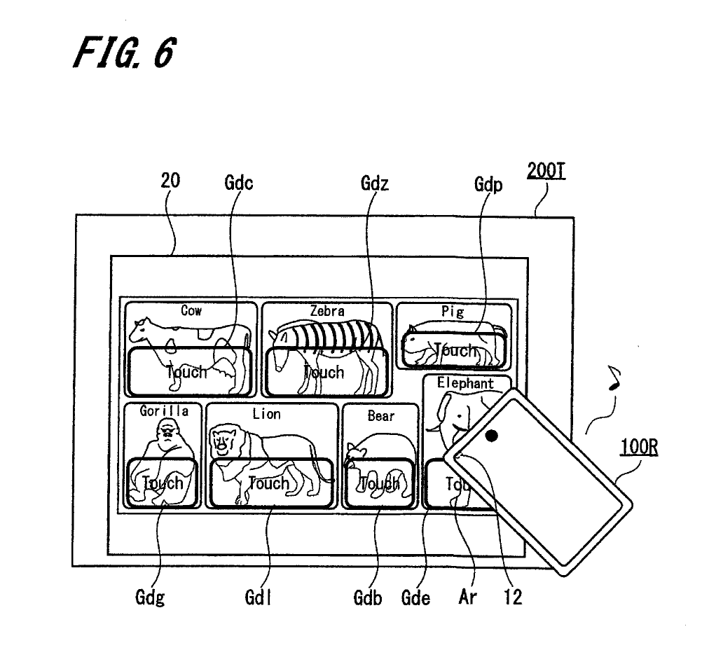

FIG. 6 illustrates a non-limiting example depicting a data transfer from a tablet (transmitting device) to a smart phone (receiving device). FIG. 6 depicts the example applied to a multimedia picture book wherein a plurality of animals such as a cow, zebra, pig, gorilla, lion, bear and an elephant are displayed on the screen of the display panel 20 of the tablet device 200T. Further the data transmission regions (Ar) for each of these animals is enclosed within guides represented by Gdc, Gdz, Gdp, Gdg, Gdl, Gdb and Gde respectively.

Information pertaining to a specific animal (for example the sound associated with the animal) that is to be transferred to the receiving device, is first selected by a user on the tablet device by using the touch operation. Further, by positioning the display screen of the tablet device 200T in a manner such that a photo sensor 13 of the mobile device is located on a particular guide Gd, the bawling i.e., sound associated with the animal drawn in the respective area is emitted via a speaker 4. The tablet device 200T modulates the data (bawling of the animal) and transmits it to the receiving device 100R. Further, note that the transmitting device 200T may transmit an identification (ID) associated with each of these animals or may send the ID to a specific URL whereupon receiving the ID, a match is made with the bawling of the animal and can be emitted from the speaker 4. Note that as shown in FIG. 6, as long as the position of the photo sensor 12 is within the area Ar, a successful transfer of data occurs. Specifically, the photo sensor 12 need not be exactly aligned with the area Ar. Note that the information to be transmitted to the receiving device is in no way restricted just to the sounds of animals. The information to be transmitted could comprise of photo pictures, web-pages, music albums or other pertinent information that needs to be exchanged by a user.

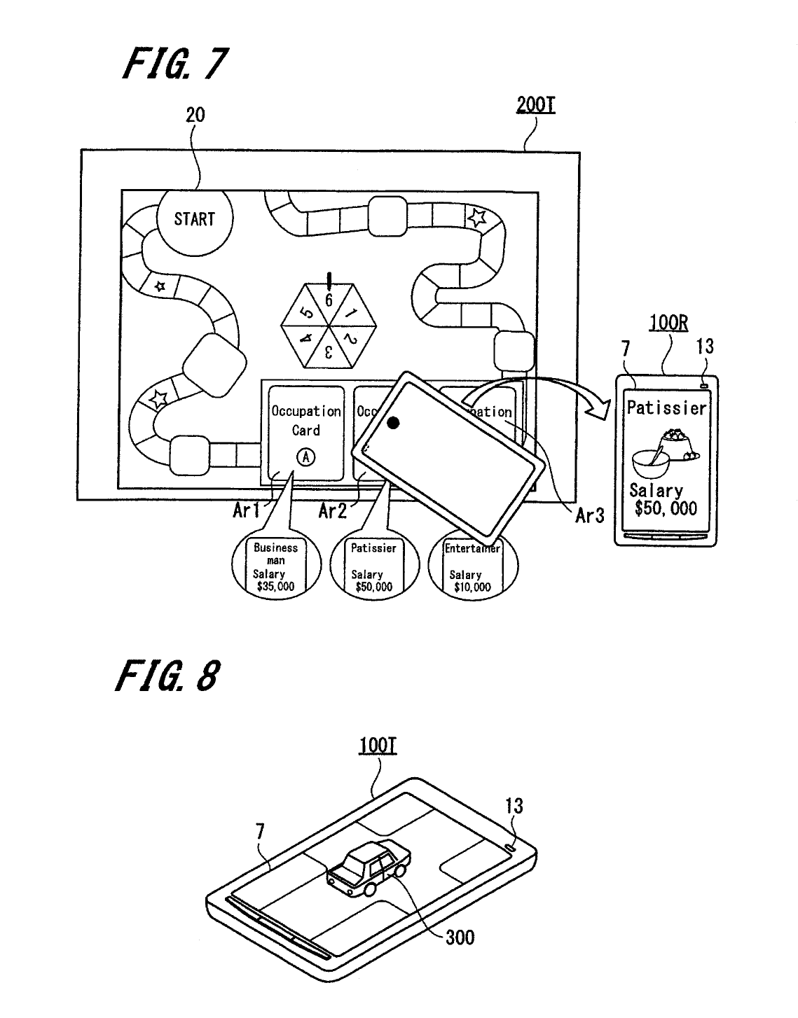

FIG. 7 illustrates another non-limiting example depicting the data transfer process in a board game. In FIG. 7 the tablet device 200T is a transmitting device and a mobile phone 100R is the receiving device. The display panel of the tablet is configured to display a board game which comprises of a disk wheel located in the center of the display and ‘occupation cards’ which are displayed in the lower right-hand corner of the display screen. FIG. 7 depicts three occupation cards with the respective transmission areas being represented by Ar1-Ar3. Contents of the occupation card are transferred and depicted on the mobile phone terminal device 100R when the photo sensor 13 is positioned in the corresponding transmission area. For example, as shown in FIG. 7 when the photo sensor 13 is disposed in the area depicted by Ar2 the contents of the Patissier occupation card are transferred to the mobile phone device and displayed on its display panel 7.

The data transfer of the respective occupation cards can be performed in several ways. According to one embodiment, a user can implement a touch operation to select the occupation card and further to modulate the data associated with the selected card and thereby transfer the data to the mobile phone when the photo-sensor is positioned within the transmission region. Alternatively, the data associated with the occupation cards may be continuously modulated and upon the photo sensor being positioned over the occupation card, the data transfer operation may be initiated. Furthermore, specific icons associated with the cards can be pre-determined to initiate the data transfer process when the photo sensor is placed over the icon. For example, icon A depicted on the first occupation card can be configured such that if the photo sensor is placed upon it, data associated with the particular card can be transferred. Further, to transfer data from the occupation card a modulation pattern is first constructed by a header that includes an ID number. Upon positioning the sensor (of the receiving terminal 100R) above the occupation card, the sensor captures the header and ID information. An application in the receiving device can be configured to display information pertaining to the ID number on a display panel.

The above mechanisms of transferring data from the transmitting device to the receiving device are in no way limiting the scope of the present invention and any suitable means of initiating the data transfer can be implemented.

Note that the photo sensor need not be exactly aligned with the transmission area. As shown in FIG. 7, when the photo sensor is positioned within the area Ar2, the contents of the occupation card are transferred to the receiving device 100R. In this example the contents of occupation card 2 that is, the Patissier and its contents (for example salary etc.) are displayed on the display panel. Further additional information may be generated when a position in any arbitrary location of the display panel 20 is selected. For example, a random number may be generated when an arbitrary location of the display panel is selected, and based on the luminance value of the selected region the random number generated may for example, be used to decide the turn value of the disk wheel.

FIG. 8 illustrates a non-limiting example depicting the control of a motor vehicle accessory (mini car) disposed on a display panel of the transmitting device 100T. The transmission device 100T transmits control information with respect to the motor vehicle accessory 300 that is driven based on control information. Note that the control information comprises for example a character code or a binary data code that is modulated by the luminance value and/or RGB value of an image which is displayed on the display panel 7 of the transmitting device 100T. A photo sensor 31 provided in the bottom surface of the motor vehicle accessory 300 detects the luminance value and/or RGB value and thereby sends control information to the motor vehicle accessory for its operation. In what follows, we first describe the structural configuration that controls the motor vehicle accessory and then illustrate different embodiments describing how the control of the motor vehicle accessory can be accomplished.

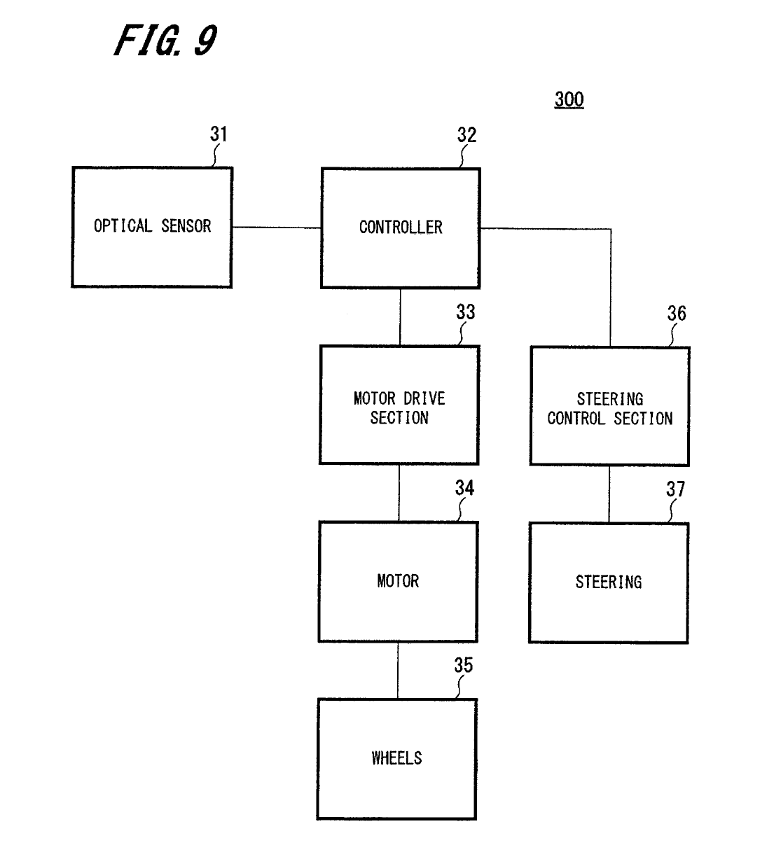

FIG. 9 illustrates a structural configuration of the components used for the data transfer in the example of FIG. 8.

Specifically, the motor vehicle accessory 300 includes a photo sensor 31, a control unit 32, a motor drive unit 33, a motor 34, wheels 35, a steering control unit 36 and steering-wheel 37.

The photo sensor 31 comprises of an illumination intensity sensor or an RGB color sensor. The control unit 32 comprises a central processing unit that controls every unit of the motor vehicle accessory 300. The control unit 32 performs a demodulation process of the data detected by the photo sensor 31 and supplies the data to the motor drive unit 33 and the steering control unit 36.

The motor drive unit 33 controls the motor 34 which in turn controls the rotation of the wheels 35. The steering wheel control unit 36 receives control instructions from the controller 32 and controls the operation of the steering 37.

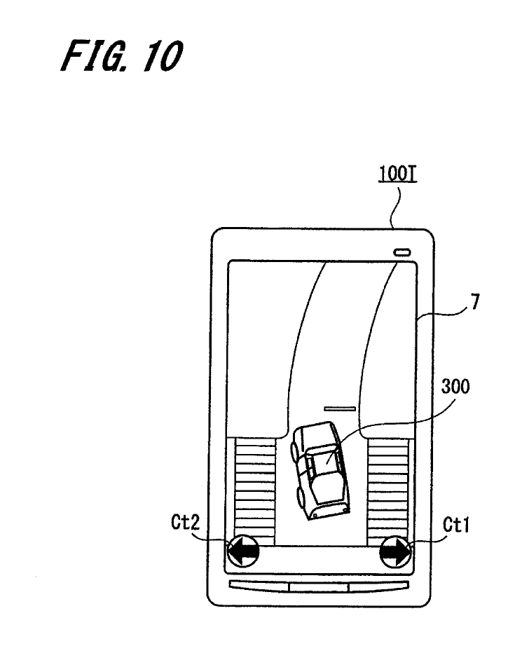

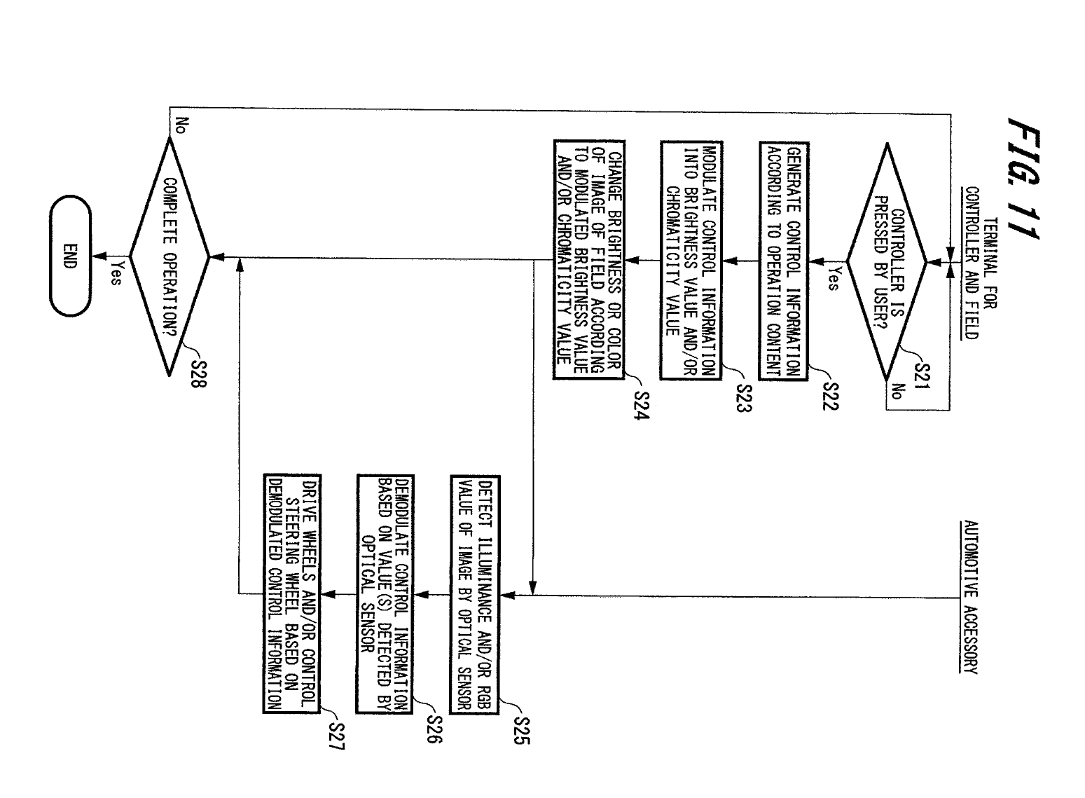

FIG. 10 illustrates a non-limiting example depicting the control of a motor accessory disposed on the display panel 7 of the transmitting device. The display panel 7 of the transmission device 100T depicts the field of the motor vehicle accessory 300 and the controllers represented as Ct1 and Ct2, which are displayed on the bottom part of the display screen. The transmission device 100T operates the motor vehicle accessory 300 by changing the luminance value and/or RGB value of the image and transmits control information and field information to the motor vehicle, which is captured by a photo sensor disposed underneath the motor vehicle accessory.

Field information refers to geographic information in the vicinity of the motor vehicle. Geographic information depicts obstructions in the road that may lie in the path of the motor vehicle. The motor vehicle is controlled by controllers Ct1 which is the first user interface and is configured for moving the motor vehicle to the right and controller Ct2 which is a second user interface that is configured to turn the motor vehicle to the left, depending on the obstructions that lie in the path of the motor vehicle accessory.

FIG. 11 illustrates an exemplary flow chart depicting the steps taken by the transmitting device 100T to control the motor vehicle accessory 300 as shown in FIG. 10.

In step S21 the transmitting device 100T continuously queries to check if a controller (Ct1/Ct2) is pressed by a user. Upon detecting that either of the controllers is pressed, the process proceeds to step S22. Note that if the controller is not pressed by a user, the process merely loops back to step S21 to continuously monitor if either of the control buttons are pressed by the user.

In step S22 the transmitting device generates control information based on whether Ct1 or Ct2 is pressed. In step S23, the transmitting device 100T modulates the control information based on the luminance value and/or the RGB value. Note that these processes are performed by the data modulation/demodulation processing unit 11 (as shown in FIG. 3) of the mobile phone terminal device.

In step S24 the luminance value and/or the RGB value of the image field is changed by the brightness value/RGB value controller (unit 12 in FIG. 3), based on the modulated data. In step S25 a photo sensor 31 of the motor vehicle accessory 300 detects the luminance value/RGB value.

Further, in step S26 the control unit 32 of the motor vehicle accessory 300 demodulates the information based on the value detected by the optical sensor and further controls the drive wheel unit and the steering wheel unit based on the demodulated control information as shown in step S27.

Upon controlling the wheels in step S27 the process proceeds to step S28 wherein a query is made if the control operation of the motor vehicle accessory is complete. If the response to the query in step S28 is affirmative, the process ends, else the process loops back to step S21 wherein the transmitting device 100T monitors for another change in the controllers Ct1 and Ct2.

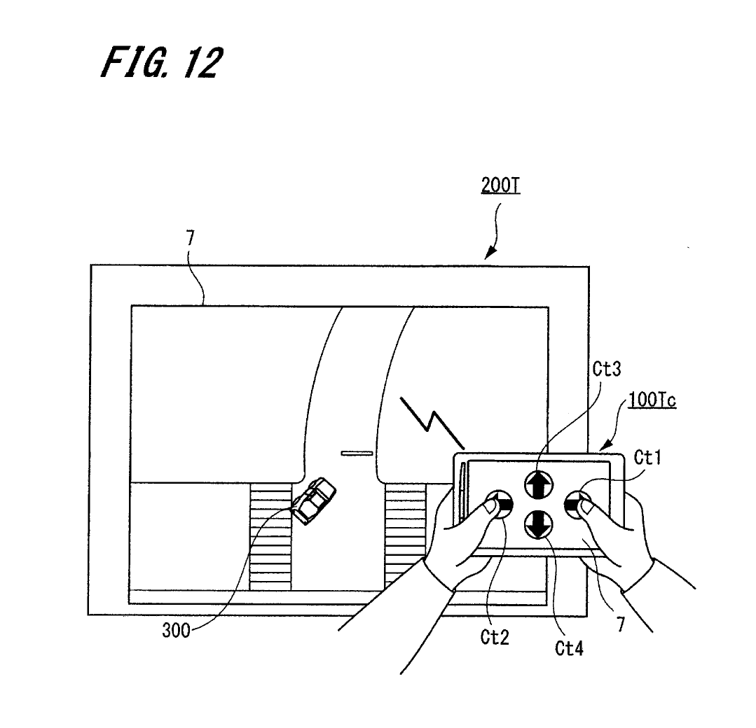

FIG. 12 illustrates another example depicting the control of a motor vehicle accessory by a remote control transmitting device. FIG. 12 depicts a transmitting device 100Tc which is a device used for transmitting control information to the receiving device 200T where upon the motor vehicle accessory 300 is disposed and which displays the field of the motor vehicle accessory. A photo sensor 31 provided in the bottom surface of the motor vehicle accessory is configured to detect the luminance value/RGB value of the image field of the tablet terminal 200T. The control information that controls the motor vehicle accessory 300 is transmitted by a remote control signal from the transmitting device 100Tc. Note that the transmitting device 100Tc is a terminal for controllers with respect to the tablet terminal 200T which is a terminal for displaying the field of the motor vehicle accessory. Further note that the control information can be transmitted by using a Bluetooth mechanism, near field communications using radio waves or the like.

Upon receiving control signals from the transmitting terminal 100Tc, the tablet device 200T controls the luminance value and/or RGB value of an image field based on the received control signals. For example, the transmitting device 100Tc depicts four control buttons Ct1-Ct4 to move the motor vehicle accessory to the left, right, forward and backward direction. Upon pressing one of the control buttons, a change in the luminance value is detected in the display panel 7 and the controller instructs the motor vehicle to move in the appropriate direction.

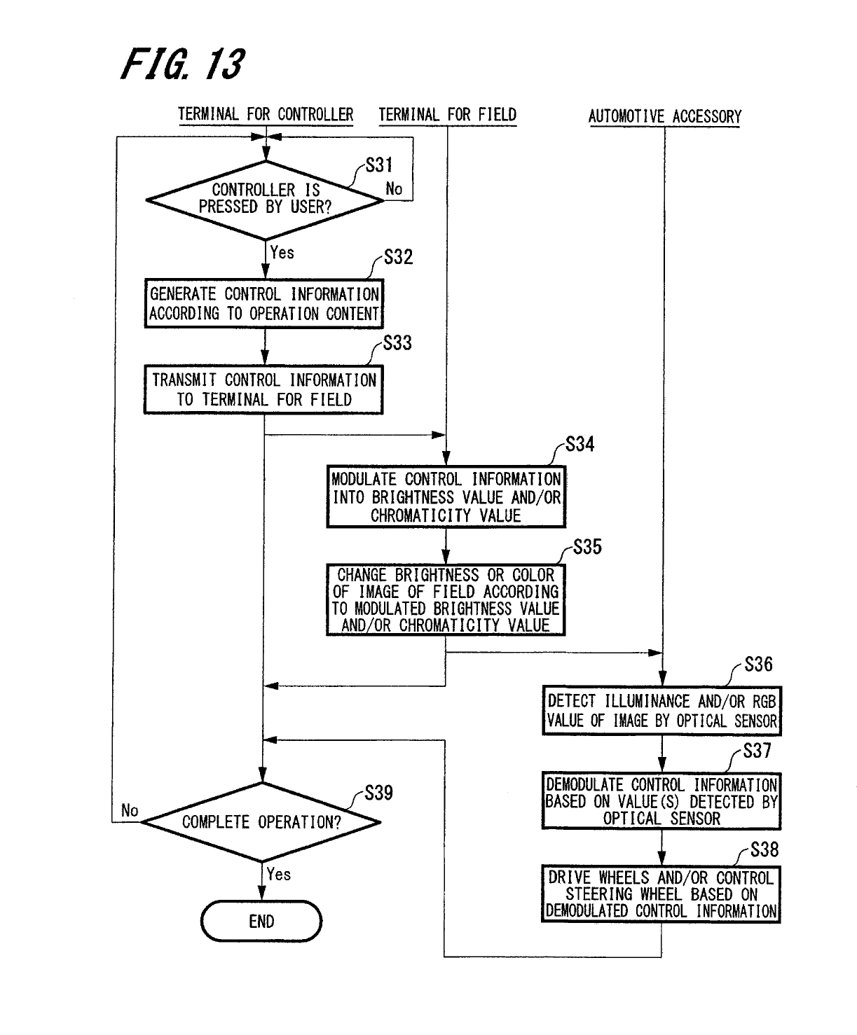

FIG. 13 illustrates an exemplary flowchart depicting the steps taken by the transmitting device to control the motor vehicle accessory of FIG. 12. FIG. 13 depicts the actions taken by the terminal for the controller, the terminal for the field, and the automotive motor vehicle accessory.

In step S31, a query is made if the control buttons Ct1-Ct4 are pressed by the user. If the response to the query is affirmative, the process proceeds to step S32, else the process loops back and checks (in step S31) if a control button is pressed.

In step S32 control information is generated (by a controller, unit 1 as shown in FIG. 3), according to the control button (Ct1-Ct4) that is pressed. In step S33 the control information generated is transmitted (wirelessly) to the terminal field of the motor vehicle accessory. In step S34 the received control information transmitted by the transmitting device 100Tc is modulated at the tablet terminal 200T.

In step S35, based on the modulated data the brightness and color of an image in the terminal field are controlled by the tablet terminal 200T. In step S36 the motor vehicle accessory detects via a photo sensor the illumination intensity and/or the RGB value of the screen on which the field is drawn. In step S37 a control unit 32 of the motor vehicle accessory 300 demodulates the control information based on values detected by the optical sensor. In step S38, based on the control information that is demodulated, the wheel 35 and the steering 37 control the motor vehicle accessory 300.

In step S39, a query is made regarding if the control operation is completed. If the response to the query is affirmative, the process ends or else loops back to step S31 wherein the controller checks if the control buttons Ct1 to Ct4 are pressed by the user.

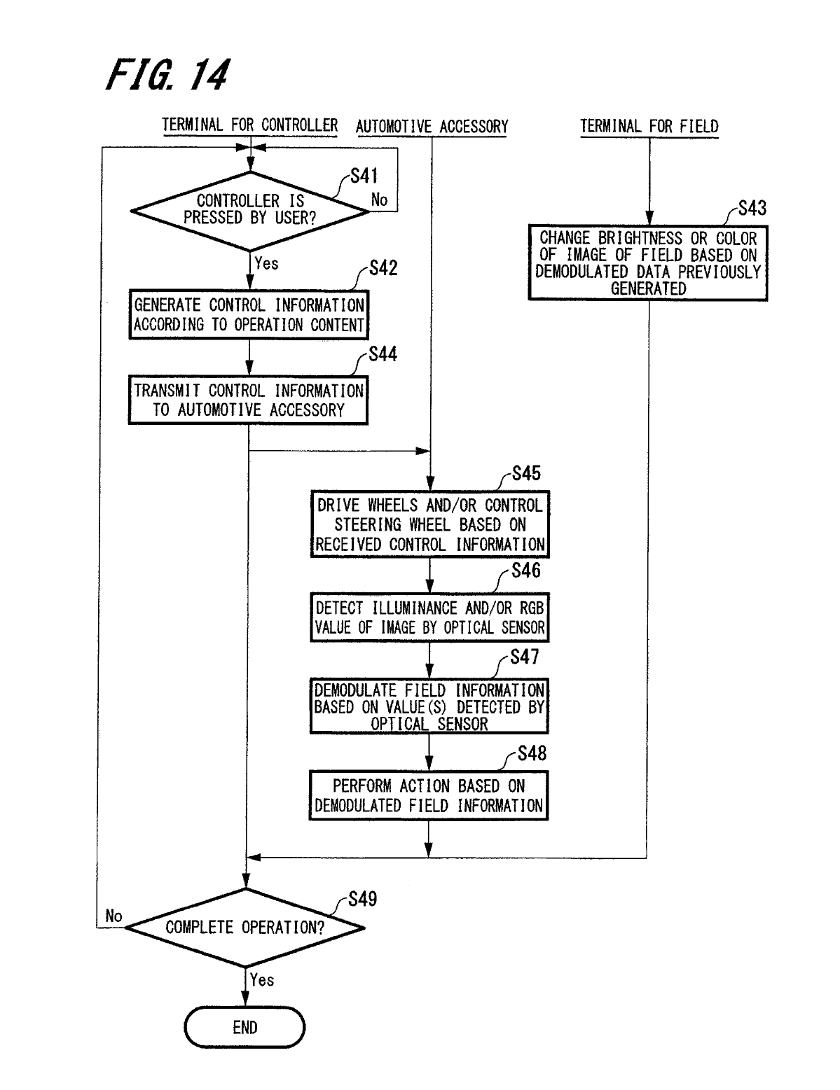

FIG. 14 illustrates an exemplary flowchart depicting another method to control the motor vehicle accessory of FIG. 12. Specifically, FIG. 14 depicts the steps undertaken wherein the motor vehicle accessory 300 is directly controlled by the remote control device. In this case, the motor vehicle accessory 300 is provided with a remote control signal reception unit. Based on the modulated data generated, the tablet device 200T changes the brightness/the color of an image and transmits field information to the motor vehicle accessory 300.

In step S41 the controller checks if either of the control buttons Ct1-Ct4 are pressed. If the response to the query in step S41 is affirmative the process proceeds to step S42 else the process loops back and remains in step S41 wherein the controller awaits for the control button to be pushed.

In step S42 control information is generated according to the control button being pressed. Further, in step S44 control information is transmitted to the automotive motor vehicle accessory. In step S43 the brightness or color of the image field is changed. In step S45, based on the control information received from the transmission device 100Tc, a wheel 35 and the steering 37 control the motor vehicle accessory 300. Further in step S46 the motor vehicle accessory 300 detects a change in the illumination intensity/RGB value of the screen via a photo sensor 31.

In step S47 the control unit 32 of the motor vehicle accessory 300 demodulates the detected value from the photo sensor 31. In step S48 the motor vehicle accessory 300 performs actions based on the demodulated field information. For example, when the motor vehicle accessory 300 is about to collide with an object in its path, the speed of the motor vehicle accessory decelerates thereby bringing the motor vehicle accessory to a stop.

In step S49 a query is made if the control operation is complete. If the response to the query is affirmative the process merely ends else the process loops back to step S41 wherein the controller continuously monitors if either of the control buttons Ct1 to Ct4 are pressed by the user.

Obviously numerous modifications and variations of the present invention are possible in the light of the above teachings. It is therefore to be understood that within the scope of the appended claims the invention may be practiced otherwise then as specifically described herein. For example, the photo sensor 31 of the motor vehicle accessory 300 can be replaced by using a solar cell that generates electric power according to the amount of light received. Further, in the receiving device 100R an imaging unit (unit 9 of FIG. 3) can be used instead of the photo sensor 13. The imaging unit may modulate the data from the acquired luminance value and/or RGB value acquired from the image signal that is input at 30 to 60 frames per second. Further, the image displayed on the screen of the transmission device 100T is not limited to a still image. A moving image can also be used.

Further the receiving device 100R may transmit data through a wireless/radio medium that uses identifiers (ID) via a Bluetooth or Wi-Fi mechanism. The transmission device 100T may transmit data by not changing the luminance value and/or RGB value of an image which are displayed on the screen and instead change the brightness or luminance of a backlit of the display panel (the unit 7). When LEDs (light emitting diodes) are used for the backlit mechanism, a brightness/luminance can be adjusted by changing the duty cycle of a pulse width modulation of the LEDs. Note that since the frequency of a pulse width modulated signal can be set to high value such as 1 kHz it can transmit more data as compared to the case where the luminance value of the image is changed. Further, each of the transmitting device 100T and the receiving device 100R can be configured to be equipped with a display unit 7 and a photo sensor 13 and that are enabled to transmit and receive data between the transmission device and the receiving device.

Note that since data is received by using a photo sensor as the medium according to the exemplary embodiments of the present disclosure, the photo sensor may be set to a transmission region Ar to any position on the screen of the transmission side terminal. Therefore, it becomes unnecessary to exactly align the transmission side device 100T and the receiving side device 100R. Further note that since the photo sensor 13 comprises of a light receiving element such as a photodiode it does not mount the photodiode on the casing of the transmitting device. Further, since light receiving elements such as photodiodes are low power consumption devices and also low cost devices, the power consumption reduction of a device and the reduction of manufacturing costs can be incurred.

Since the illumination intensity sensor is mounted in many examples it becomes unnecessary to add new components to the mobile phone terminal device or a smart phone. With regard to the mobile phone terminal device (or the smart phone) that are positioned in the vicinity of a screen off the display unit 7 the photo sensor 13 can transmit or receive data by simple operation of mutually setting a screen.

Additionally devices other than the mobile phone terminal device may be used to perform the features discussed in the present disclosure. For example aspects of the present disclosure may be executed by a tablet, a smart phone, a general purpose computer, a laptop, an electronic reading device or any other such display terminals.

The above disclosure also encompasses the embodiments noted below:

(1) An information processing apparatus comprising: circuitry configured to modulate data to be communicated to another information processing apparatus; and control a display to modify at least one of a luminance value and a color value of information displayed at the display with respect to time based on the modulated data.

(2) The information processing apparatus of (1), wherein the displayed information is in a predetermined region of the display and is enclosed by a guide.

(3) The information processing apparatus of (2), wherein the modified at least one of a luminance value and a color value is detected by a sensor of another information processing apparatus, when the sensor of the another information processing apparatus is positioned in a location coinciding with the guide.

(4) The information processing apparatus of (1), wherein the modified at least one of a luminance value and a color value is detected by a sensor of another information processing apparatus, and the another information processing apparatus is further configured to demodulate the data based on the detection at the sensor.

(5) The information processing apparatus of (4), wherein the sensor is configured to detect a change in the at least one of the luminance value and the color value of the information displayed at the display.

(6) The information processing apparatus of (5), wherein the another information processing apparatus is configured to demodulate the data based on a magnitude of the change in at least one of the luminance value and the color value detected by the sensor.

(7) The information processing apparatus of (4), wherein the sensor is selected from the group consisting of an optical sensor, an illumination sensor and a red blue green color intensity sensor.

(8) The information processing apparatus of (1), wherein the circuitry is configured to control the display to display a plurality of information enclosed within corresponding guides and communicate the data to the another information processing apparatus by modifying at least one of a luminance value and a color value of the plurality of information enclosed within corresponding guides.

(9) The information processing apparatus of (1), wherein the circuitry modulates the data to be communicated based on at least one of the luminance value and the color value of the information displayed on the display.

(10) The information processing apparatus of (1), wherein the circuitry modulates the data to be communicated based on a luminance value of the display.

(11) The information processing apparatus of (1), wherein the data to be communicated is control data that controls the another information processing apparatus when the another information processing apparatus is disposed on a surface of the display.

(12) The information processing apparatus of (1), wherein the circuitry is further configured to receive control data and generate the data to be transmitted to the another information processing apparatus, when the another information processing apparatus is disposed on a surface of the display.

(13) The information processing apparatus of (12), wherein the received control data includes a control command which controls an operation of an accessory disposed on a surface of the display and the modulated data is generated by modifying at least one of the luminance value and the color value of the display.

(14) The information processing apparatus of (13), wherein the accessory is controlled to move in a desired direction based on a corresponding change in at least one of the luminance value and the color value indicated by a corresponding controller.

(15) The information processing apparatus of (14), wherein the accessory is a is a motor vehicle.

(16) The information processing apparatus of (4), wherein the other information processing apparatus is configured to generate a random number based on at least one of the luminance value and the color value detected by the sensor.

(17) An information processing method performed by an information processing apparatus, the method comprising: modulating data to be communicated to another information processing apparatus; and controlling a display to modify at least one of a luminance value and a color value of information displayed at the display with respect to time based on the modulated data.

(18) A non-transitory computer-readable medium including computer program instructions, which when executed by an information processing apparatus, cause the information processing apparatus to perform a process, the process comprising: modulating data to be communicated to another information processing apparatus; and controlling a display to modify at least one of a luminance value and a color value of information displayed at the display with respect to time based on the modulated data.

1. An information processing apparatus comprising:
circuitry configured to
modulate data to be communicated to another information processing apparatus; and
control a display to modify at least one of a luminance value and a color value of information displayed at the display with respect to time based on the modulated data.

2. The information processing apparatus of claim 1, wherein the displayed information is in a predetermined region of the display and is enclosed by a guide.

3. The information processing apparatus of claim 2, wherein the modified at least one of a luminance value and a color value is detected by a sensor of another information processing apparatus, when the sensor of the another information processing apparatus is positioned in a location coinciding with the guide.

4. The information processing apparatus of claim 1, wherein the modified at least one of a luminance value and a color value is detected by a sensor of another information processing apparatus, and the another information processing apparatus is further configured to demodulate the data based on the detection at the sensor.

5. The information processing apparatus of claim 4, wherein the sensor is configured to detect a change in the at least one of the luminance value and the color value of the information displayed at the display.

6. The information processing apparatus of claim 5, wherein the another information processing apparatus is configured to demodulate the data based on a magnitude of the change in at least one of the luminance value and the color value detected by the sensor.

7. The information processing apparatus of claim 4, wherein the sensor is selected from the group consisting of an optical sensor, an illumination sensor and a red blue green color intensity sensor.

8. The information processing apparatus of claim 1, wherein the circuitry is configured to control the display to display a plurality of information enclosed within corresponding guides and communicate the data to the another information processing apparatus by modifying at least one of a luminance value and a color value of the plurality of information enclosed within corresponding guides.

9. The information processing apparatus of claim 1, wherein the circuitry modulates the data to be communicated based on at least one of the luminance value and the color value of the information displayed on the display.

10. The information processing apparatus of claim 1, wherein the circuitry modulates the data to be communicated based on a luminance value of the display.

11. The information processing apparatus of claim 1, wherein the data to be communicated is control data that controls the another information processing apparatus when the another information processing apparatus is disposed on a surface of the display.

12. The information processing apparatus of claim 1, wherein the circuitry is further configured to receive control data and generate the data to be transmitted to the another information processing apparatus, when the another information processing apparatus is disposed on a surface of the display.

13. The information processing apparatus of claim 12, wherein the received control data includes a control command which controls an operation of an accessory disposed on a surface of the display and the modulated data is generated by modifying at least one of the luminance value and the color value of the display.

14. The information processing apparatus of claim 13, wherein the accessory is controlled to move in a desired direction based on a corresponding change in at least one of the luminance value and the color value indicated by a corresponding controller.

15. The information processing apparatus of claim 14, wherein the accessory is a is a motor vehicle.

16. The information processing apparatus of claim 4, wherein the other information processing apparatus is configured to generate a random number based on at least one of the luminance value and the color value detected by the sensor.

17. An information processing method performed by an information processing apparatus, the method comprising:
modulating data to be communicated to another information processing apparatus; and
controlling a display to modify at least one of a luminance value and a color value of information displayed at the display with respect to time based on the modulated data.

18. A non-transitory computer-readable medium including computer program instructions, which when executed by an information processing apparatus, cause the information processing apparatus to perform a process, the process comprising:
modulating data to be communicated to another information processing apparatus; and
controlling a display to modify at least one of a luminance value and a color value of information displayed at the display with respect to time based on the modulated data.
